(19) United States
(12) Patent Application Publication
(10) Pub. No.: US 2026/0138146 A1
(43) Pub. Date: May 21, 2026

(54) SUNSCREEN FLUID DISPENSING APPARATUS

(71) Applicant: XSPF LLC, Middletown, DE (US)

(72) Inventor: Rick Bouza, Montrose, NY (US)

(73) Assignee: XSPF LLC, Middletown, DE (US)

(21) Appl. No.: 19/391,240

(22) Filed: Nov. 17, 2025

Related U.S. Application Data
(60) Provisional application No. 63/722,190, filed on Nov. 19, 2024.

(51) Int. Cl. B05B 13/04; B05B 16/40

(52) U.S. Cl. CPC B05B 13/041; B05B 16/40

(57) ABSTRACT

A sunscreen fluid dispensing apparatus includes a sunscreen reservoir system for dispensing the sunscreen fluid. The sunscreen reservoir is in fluid communication with one or more pumps. The sunscreen fluid dispensing apparatus includes an air compressor and one or more posts mounted to a base. The sunscreen fluid dispensing apparatus includes a sprayer carriage movably mounted to each of the posts. The sprayer carriage is in fluid communication with the air compressor and the at pumps. The sprayer carriage has one or more nozzles mounted thereon and configured to discharge a mixture of air and the sunscreen fluid through a discharge port of each of the nozzles.

### CROSS REFERENCE TO RELATED APPLICATIONS

This application claims the benefit and priority of U.S. Provisional Patent Application No. 63/722,190, filed on November 19, 2024, entitled “Fluid Dispensing Apparatus,” the entirety of which is incorporated herein by reference.

### TECHNICAL FIELD

The present invention relates to automated dispensing kiosks and, in particular, to a self-service sunscreen application kiosk that provides both automated full-body spray and manual face/neck lotion dispensing, with user-sensing capabilities and maintenance-friendly design.

### BACKGROUND

Most people agree that application of lotions, such as sunscreen lotions and liquids, is important for protection against sun related skin damage such as sunburn. Uniform application of lotions, such as sunscreen lotion to the human body, has been difficult to achieve. For example, it is difficult for humans to reach, apply and distribute such lotions to certain parts of their bodies such as to their backs. Furthermore, some people are discouraged from applying such lotions to their bodies because it is messy or time consuming. Thus, few people consistently apply such lotions because of the foregoing inconvenience. In addition, some lotion dispensing systems require the human to be contained in a closed chamber. Some people have claustrophobic feelings about being contained in such closed chambers. Therefore, some people like to have an option to quickly exit a lotion dispensing device.

Outdoor recreational areas such as beaches, pools, and parks require patrons to apply sunscreen to protect against harmful ultraviolet (UV) radiation. Existing sunscreen dispensers often involve manual application from a single nozzle or bottle, which can be time-consuming, inconvenient, and may result in uneven coverage. Fully automated spray systems risk overspray on the face or eyes and can create slippery surfaces due to excess lotion accumulation.

There is an additional issue that few people apply the right amount of lotion. Studies show that they apply less than half the proper quantity (g/cm2) of lotion.

Based on the foregoing, there is a need for an improved sunscreen fluid or lotion dispensing system that addresses the above stated problems.

### SUMMARY

There is disclosed herein a lotion (e.g., sunscreen lotion) sunscreen fluid dispensing apparatus, which includes a sunscreen reservoir system for dispensing the sunscreen fluid. The sunscreen reservoir is in fluid communication with one or more pumps. The sunscreen fluid dispensing apparatus includes an air compressor and one or more posts mounted to a base. The sunscreen fluid dispensing apparatus includes a sprayer carriage movably mounted to each of the posts. The sprayer carriage is in fluid communication with the air compressor and the pumps. The sprayer carriage has one or more nozzles mounted thereon and is configured to discharge a mixture of air and the sunscreen fluid through a discharge port of each of the nozzles.

In some embodiments, the sprayer carriage is moveably mounted on a toothed rack and is driven by a gear, and a motor configured to drive the gear, the sprayer carriage being supported by a rod end that rolls in a linear bearing.

In some embodiments, the sprayer carriage slides in a track and is mounted on a timing cable or belt wrapped around an upper pulley and a lower pulley; the timing cable or belt is driven by a stepping motor to translate the sprayer carriage relative to the post.

In some embodiments, the sprayer carriage includes one or more air valves configured to selectively control flow of air through the nozzles and one or more sunscreen valves configured to selectively control flow of the sunscreen fluid through nozzles.

In some embodiments, the sunscreen reservoir system is configured for storing sunscreen fluids having different sun protection factors.

In some embodiments, the sunscreen fluid dispensing apparatus includes a computer processing unit having executable software configured for controlling a position of the sprayer carriage and for controlling the open/closed position of the sunscreen valve(s) and the air valve(s).

In some embodiments, the sunscreen fluid dispensing apparatus includes a control and status panel mounted on one of the posts, the control and status panel is in communication with the computer processing unit and is configured to receive user selections of the sunscreen fluids and payment methods.

In some embodiments, the sunscreen fluid dispensing apparatus includes a camera (e.g., video camera) mounted on the post(s) and in communication with the computer processing unit.

In some embodiments, the sunscreen fluid dispensing apparatus includes four of the posts mounted diametrically opposite one another on the base and with nozzle(s) facing each other.

In some embodiments, the sunscreen fluid dispensing apparatus includes one or more wind break walls, each of which extending between adjacent pairs of posts.

In some embodiments, the base includes a grate mounted therein which is configured for supporting a user (e.g., a human being).

In some embodiments, the sunscreen fluid dispensing apparatus includes a solar panel configured to provide electricity to at least one of a battery bank, the pumps, the computer processing unit, the air valve, the sunscreen valve, and the motor.

A more detailed explanation of the apparatus and system is provided in the following description and claims and is illustrated in the accompanying drawings.

### BRIEF DESCRIPTION OF THE DRAWINGS

FIG. 1 is a perspective view of a sunscreen fluid dispensing apparatus of the present invention;

FIG. 2 is a perspective view of the sunscreen fluid dispensing apparatus of FIG. 1, shown with an optional wind wall breaker attached thereto;

FIG. 3 is a top view of the foundation base of the sunscreen fluid dispensing apparatus of FIG. 1;

FIG. 4 is a top view of the foundation base of the sunscreen fluid dispensing apparatus of FIG. 1;

FIG. 5 is a side view of the foundation base of the sunscreen fluid dispensing apparatus of FIG. 4;

FIG. 6 is a cross sectional view of the foundation base FIG. 5 take across section A-A;

FIG. 7 is a front view of a post of the sunscreen fluid dispensing apparatus of FIG. 1;

FIG. 8 is a cross sectional view of the post of FIG. 7 taken across section B-B of FIG. 7;

FIG. 9 is a front perspective view of the post of FIG. 7;

FIG. 10 is a front perspective view of a spray carriage of the sunscreen fluid dispensing apparatus of FIG. 1;

FIG. 11 is a back perspective view of a spray carriage of the sunscreen fluid dispensing apparatus of FIG. 1;

FIG. 12 is a perspective view of a master box of the sunscreen fluid dispensing apparatus of FIG. 4;

FIG. 13 is a top view of a master box of the sunscreen fluid dispensing apparatus of FIG. 12;

FIG. 14 is a side view of a master box of the sunscreen fluid dispensing apparatus of FIG. 12;

FIG. 15 is a side view of a portion of the carriage rail and pinion;

FIG. 16 is a front view of the carriage mounted on the rail and showing the nozzles;

FIG. 17 is a perspective view of the carriage mounted on the rail with the cover removed;

FIG. 18A is back perspective view of the manual face dispense box;

FIG. 18B is front perspective view of the manual face dispense box;

FIG. 19 is a side view of a portion of the carriage mounted on the rail;

FIG. 20 is a schematic view of the carriage mounted on a track and employing a drive system for moving the carriage.

### DETAILED DESCRIPTION

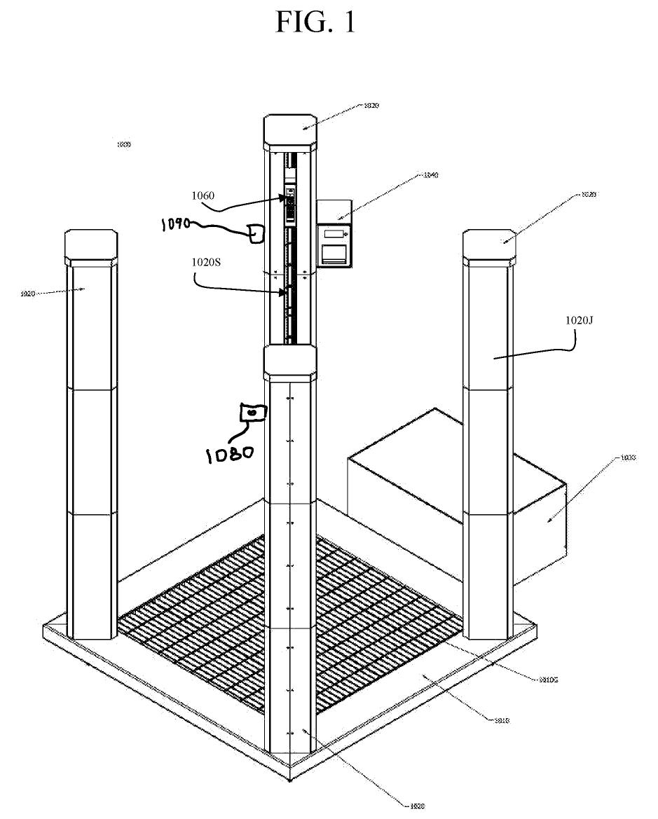

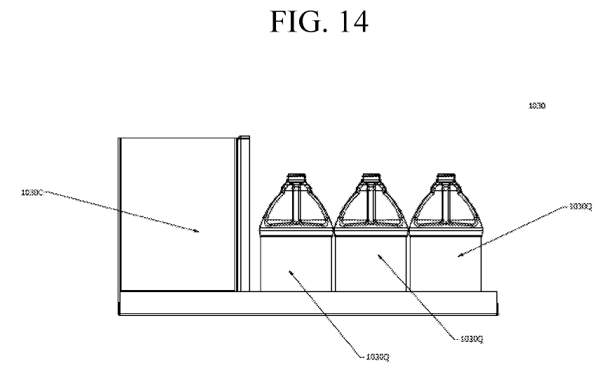

As shown in FIGS. 1, 1 and 14, sunscreen fluid (e.g., sunscreen lotion) dispensing apparatus 1000 includes a utility box 1030 which includes a sunscreen reservoir system 1030Q for dispensing (e.g., dispersing) the sunscreen fluid; the sunscreen reservoir is in fluid communication with one or more transfer units, such as pumps 1030P or a pumping system, also located in the utility box 1030. An air compressor 1030A is located in the utility box 1030. In some embodiments, the reservoir system 1030Q includes a plurality of tanks. For example, in some embodiments each SPF type of sunscreen lotion has separate tank. These tanks connect to the pumping system or are pressurized by a compressed air piston to dispense. If pumps are used, in some embodiments there is one pump per SPF to avoid cross contamination, but in some embodiments a single pump is used but with higher purge costs.

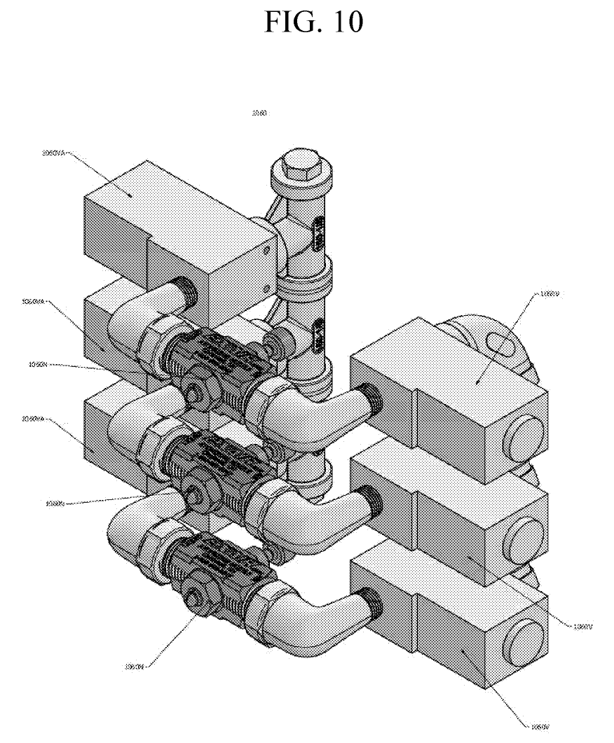

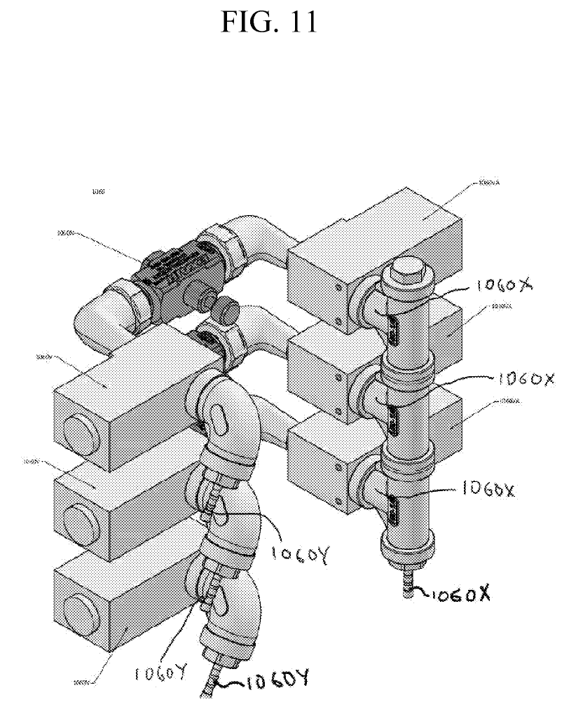

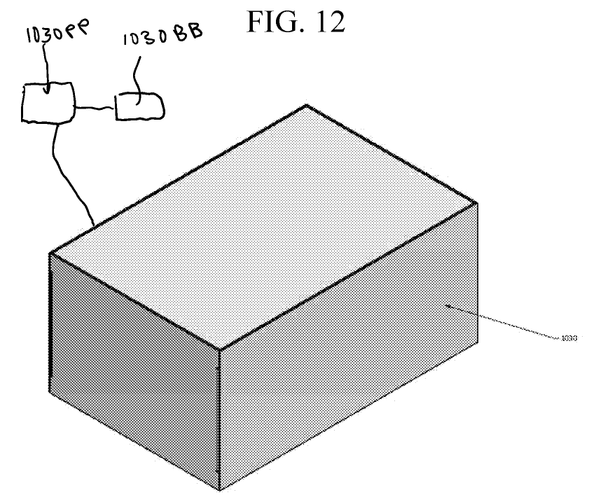

The sunscreen fluid (e.g., sunscreen lotion) dispensing apparatus 1000 includes one or more posts 1020 (e.g., made of metal, steel or composite material) mounted to a base 1010 (e.g., made of metal, steel or composite material). In the embodiment shown in FIG. 1, four posts 1020 are employed. The sunscreen fluid (e.g., sunscreen lotion) dispensing apparatus 1000 includes a sprayer carriage 1060 (see FIGS. 10 and 11) movably mounted to each of the posts 1020. The sprayer carriage 1060 is in fluid communication with the air compressor 1030A and the pump 1030P. The sprayer carriage 1060 has one or more nozzles 1060N (e.g., 3 nozzles shown) mounted thereon and configured to discharge a mixture of air and the sunscreen fluid through a discharge port of each of the nozzles 1060N. The inventor has surprisingly discovered that one nozzle 1060N (e.g., one nozzle of each of three SPF’s) is an optimum configuration that achieves proper atomization of the high viscosity sunscreen lotion. While three nozzles 1060N are shown and described one for each SPF, the present invention is not limited in this regard fewer nozzles may be employed, for example one nozzle used for all SPFs, but with more purging losses.

In some embodiments, each of the posts 1020 include a housing 1020J which has a slot 1020S extending therethrough and the discharge ports are aligned with the slot 1020S, each of which are configured to provide a flow path for the sunscreen fluid to flow through when discharged via the discharge ports in each of the nozzles 1060N, as shown in FIGS. 10 and 11.

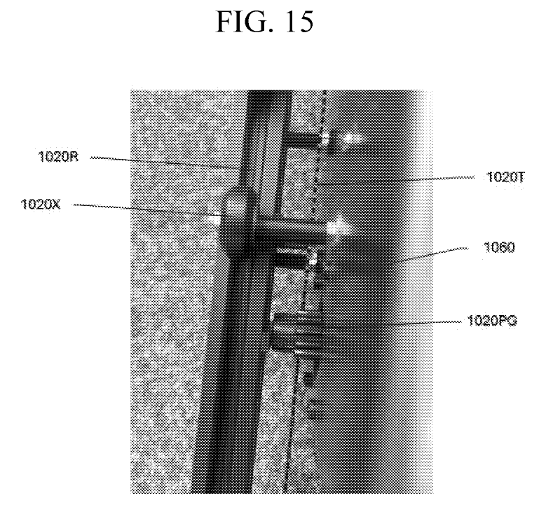

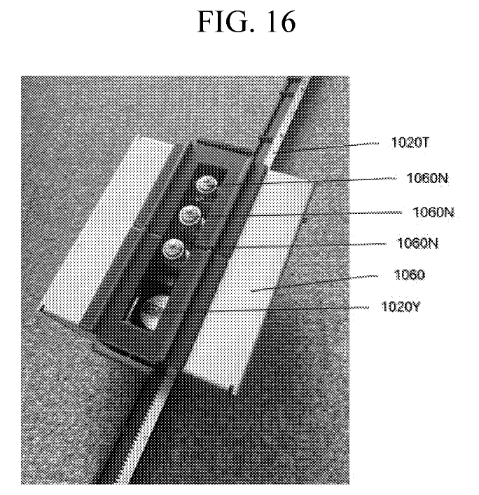

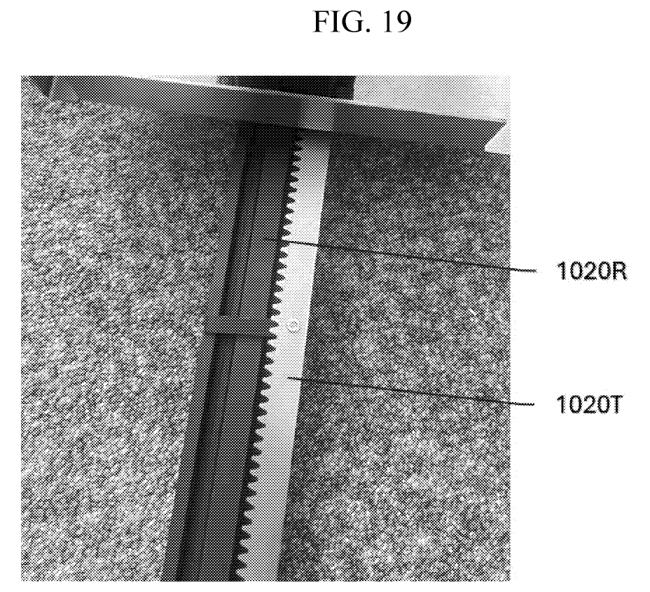

As shown in FIGS. 15, 16 and 19, for example, the sprayer carriage 1060 is moveably mounted on a toothed rack 1020T and is driven by a gear 1020PG (e.g., a pinion, spur or worm gear). The gear 1020PG is driven by a motor 1020Y (e.g., a stepping motor, with a brake), as shown in FIG. 16. The inventor has surprisingly discovered that mounting the motor 1020Y in the post 1020 keeps the motor 1020Y away from a drip path of excess sunscreen lotion and keeping sand away from the bottom of the post 1020, thereby extending the life of the motor 1020Y. The sprayer carriage 1060 is supported by a V-wheel or rod end 1020X that rolls in a linear groove 1020R or a linear bearing can be employed. The stepping motor 1020Y has utility in enabling the carriage 1060 to climb the rack 1020T and helps prevent sand and other debris from contaminating the sprayer carriage 1060 and interconnected components. In some embodiments, the sprayer carriage 1060 is moveably mounted on a toothed rack 1020T (e.g., a track) and is driven by a gear 1020PG. The sprayer carriage 1060 is supported by a V-wheel or rod end 1020X that rolls in the linear groove 1020R.

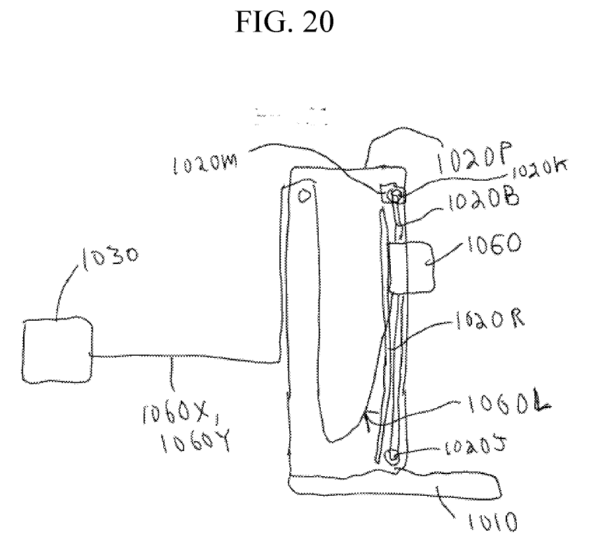

In some embodiments, the sprayer carriage 1060 slides in a track, preferably a linear bearing 1020R and is mounted on a timing cable or belt 1020B wrapped around an upper pulley 1020K and a lower pulley 1020J, the timing cable or belt is driven by a stepping motor 1020Y to translate the sprayer carriage 1060 relative to the post 1020, as shown in FIG. 20.

As shown in FIGS. 10 and 11, the sprayer carriage 1060 includes three air valves 1060VA (e.g., three solenoid valves shown) configured to selectively control flow of air through the nozzles 1060N. One air valve 1060VA is used for each of the three air supply lines 1060X (e.g., tubing including fittings such as barbed fitting), thus if only one SPF is sued there is only one nozzle 1060N and only one solenoid valve 1060VA. The sprayer carriage 1060 includes three sunscreen valves 1060V (e.g., three solenoid valves shown, each of which are the lotion solenoid valves that control the flow of the sunscreen lotion or fluid.) configured to selectively control flow of the sunscreen fluid through the nozzles 1060N which are air atomizing nozzles that takes lotion on one side and compressed air on the other.

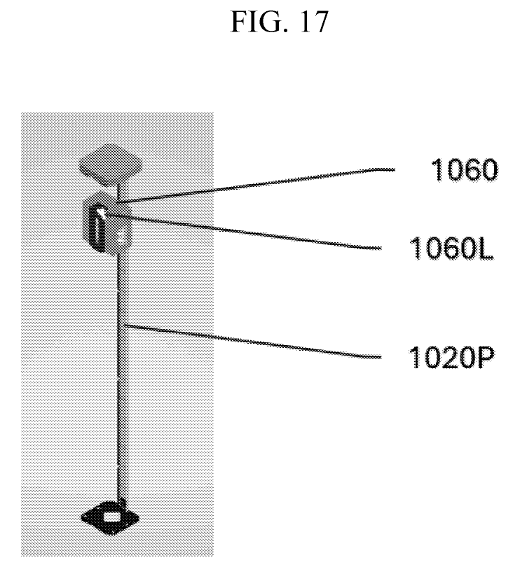

. One sunscreen valve 1060VA is used for each of the three sunscreen supply lines 1060Y including fittings such as barbed fittings. The sprayer carriage 1060 includes a sensor 1060L (see FIG. 17, e.g., a laser sensor or camera) mounted thereon for tracking the location of the user in the sunscreen fluid dispensing apparatus 1000. In some embodiments, the sensor 1060L is a time-of-flight sensor having an infra-red laser therein. The sensors 1060L are used to confirm the location of the user between the posts 1020 and also to determine where the top of the user’s head is located. Based on this, the sensors 1060L are used to provide location data coordinates of the user and for the computer processing unit 1030C to provide signals to guide the user to stand in the middle of the base 1010. The sensors 1060L also communicate with the computer processing unit to control the sprayer carriage 1060 movement (e.g., stop and start movement) and to stop spraying, at the user’s neck, so the nozzles 1060N do not spray sunscreen fluid or lotion on the user’s hair/face. On the front surface of the sprayer carriage 1060 (i.e., at the top and bottom of the sprayer carriage), are buttons or sensors that sense if there is an obstruction (like fingers, hands, or other object).

By controlling the sprayer carriage 1060, the sunscreen is delivered in a way to avoid spraying the sunscreen onto the face of a user. In some embodiments, the computer processor includes software for measuring where the top of the user’s head is located and then using typical human proportions to determine the neck height. In some embodiments, the cameras 1080 provide data input to the computer processor to control the sprayers carriages to lessen the application of lotion on undesired surfaces, such as hair or clothes, or deal with users oriented in nonstandard positions, such as sitting, kneeling.

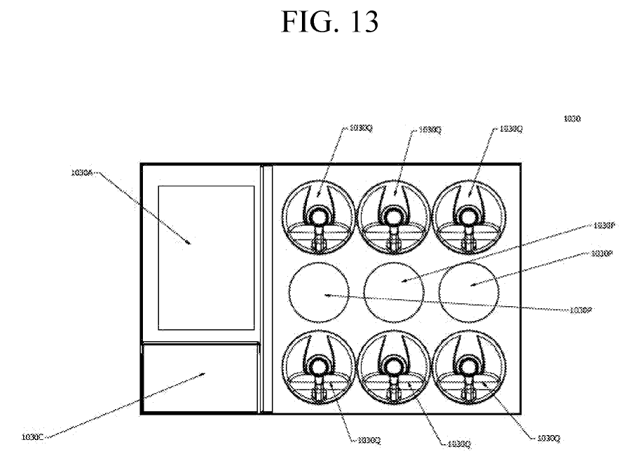

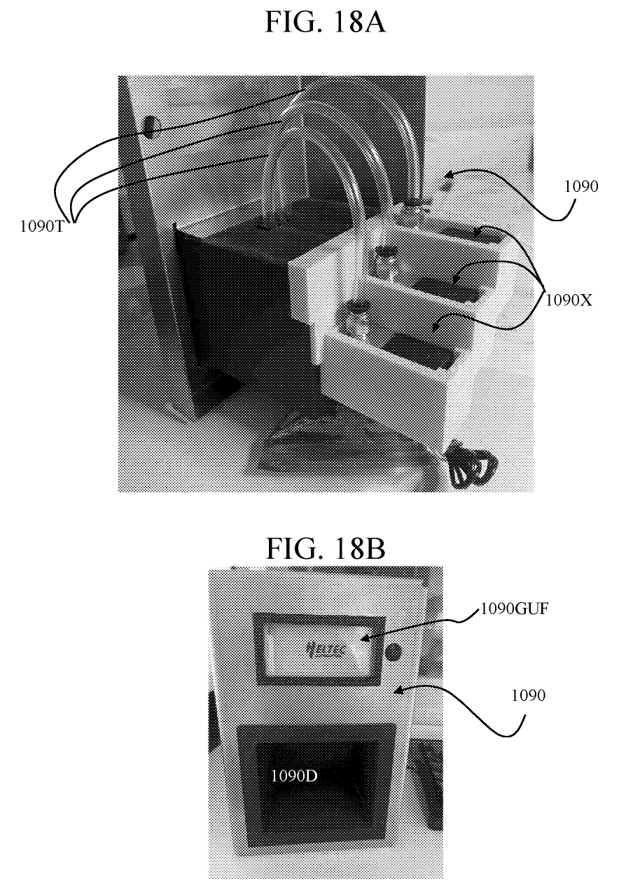

As shown in FIG. 13, the utility box 1030 includes six sunscreen reservoirs (e.g., jugs)1030Q that are configured for storing sunscreen fluids having different sun protection factors (SPF). Two of the reservoirs 1030Q contain sunscreen fluid having an SPF of 15, two of the reservoirs 1030Q contain sunscreen fluid having an SPF of 30, and two of the reservoirs contain sunscreen fluid having an SPF of 50. While six reservoirs 1030Q are shown and described having three different sunscreen SPF’s, the present invention is not limited in this regard as any number of reservoirs may be employed each having any sunscreen SPF. The sunscreen fluid and the air are transported to the sprayer carriage from the pumps 1030P and the air compressor 1030A, respectively, via a bank of hoses 1060X, 1060Y, as shown in FIG. 11 and 18. The reservoirs 1030Q are removable to facilitate replacement when needed. The reservoirs 1030Q are self-leveling and are mounted on load cells to sense how much sunscreen fluid is in the reservoir 1030Q.

As shown in FIGS. 13 and 14, the sunscreen fluid dispensing apparatus 1000 includes a computer processing unit 1030C having executable software configured for controlling a position of the sprayer carriage 1060 and for controlling the open/closed position of the sunscreen valves 1060V and air valves 1060VA, shown in FIGS. 10 and 11. A sensor 1060L (e.g., a laser distance sensor) is mounted on a portion of each carriage 1060, as shown in FIG. 17. The sensors 1060L are in communication with the computer processing unit 1030C and measure how much time it takes for a laser beam emitted from the sensor 1060L to travel out to the person in the sunscreen fluid dispensing apparatus 1000 and back to the sensor 1060L. The sensor 1060L is accurate to the millimeter. The sensor 1060L determines if a person is in the sunscreen fluid dispensing apparatus 1000, or if there is no person present in the sunscreen fluid dispensing apparatus 1000. As the sprayer carriage 1060 shifts upward, with the sensor 1060L mounted on top of the sprayer carriage 1060, the sensor 1060L scans inches above where the nozzles 1060N on the sprayer carriage is aiming at. Before spraying, the sensor 1060L can check to see if someone is in the sunscreen fluid dispensing apparatus 1000 and properly placed therein. Then, as the sprayer carriage 1060 moves upward, the sensor 1060L looks for where the top of the user’s head is. Once the sensor 1060L measures where the top of the user’s head is, the sensor 1060L determines where the top of the torso is and where to stop spraying to avoid hitting eyes. In some embodiments, there are four sensors 1060L, each mounted on a respective one of four sprayer carriages 1060 moveably mounted in a respective one of four posts. Each of the four sensors 1060L are in communication with the computer processing unit 1030C to determine the location and position of the user in the sunscreen fluid dispensing apparatus 1000, to control the position of the sprayer carriage 1060, and to generate signals to instruct the user where to move to in order to optimize the application of the sunscreen.

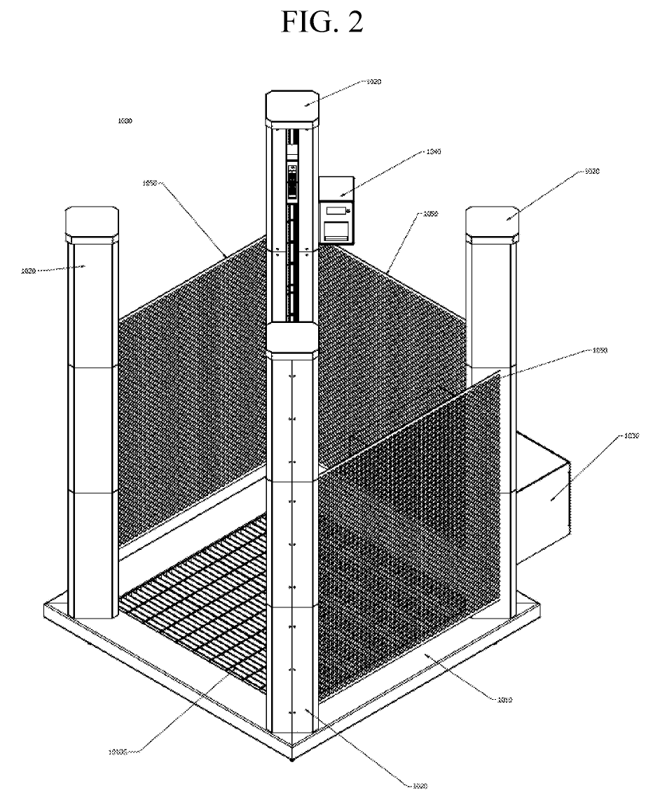

As shown in FIGS. 1 and 2, the sunscreen fluid dispensing apparatus 1000 includes a control and status panel 1040 mounted on one of the posts 1020. The control and status panel 1040 is in communication with the computer processing unit 1030C and is configured to receive user selections of the sunscreen fluids and payment methods.

As shown in FIG. 1, a camera 1080 is mounted on one or more of the posts 1020 and in communication with the computer processing unit 1030C. The camera 1080 is used for security purposes and/or provide data input to the computer processor to more accurately dispense the lotion onto the user.

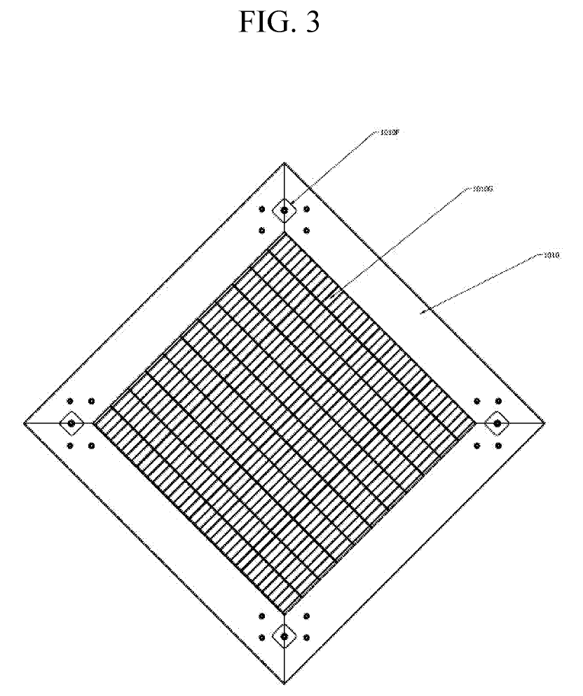

As shown in FIGS. 1 and 2, the four posts 1020 are mounted diametrically opposite one another on the base 1010 and with the nozzles 1060N facing each other. As shown in FIG. 3, in some embodiments, wind break walls 1050 (e.g., perforated panels made of plastic or metal) extend between adjacent pairs of the posts 1020.

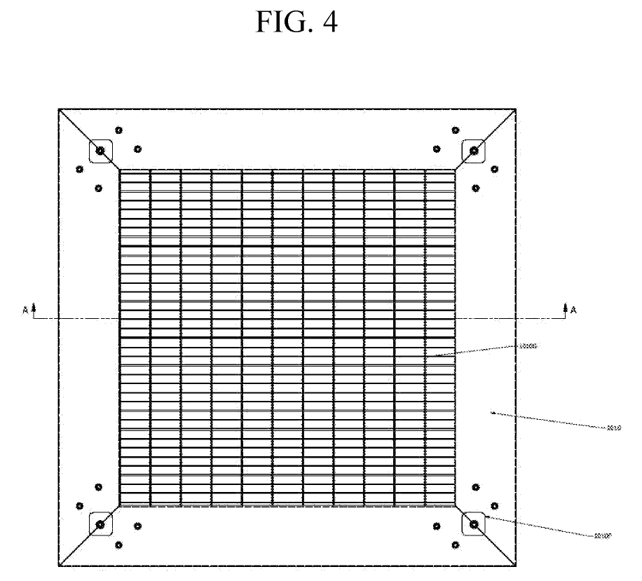

As shown in FIGS. 4-6, the base 1010 includes a grate 1020G mounted therein and configured for supporting a user (i.e., a person).

The compressed air will distribute the sunscreen fluid in a fine mist and will naturally wash away after falling through the grate 1010G. There will be minimal residue due to the design of the nozzles 1060N. Also, the sunscreen fluid is completely safe for the environment. The nozzles 1060N have very little to no drip when the sunscreen fluid is not being sprayed. The compressed air is released first to the sprayer carriage 1060, then transport the sunscreen fluid. After the spraying is complete, the sunscreen fluid supply is terminated first followed by terminating the flow of compressed air, which keeps the nozzles 1060N clean. The grate 1010G has utility in allowing drainage of excess sprayed lotion so as not to build up a slippery surface.

The sunscreen fluid dispensing apparatus 1000 (e.g., kiosk) of the present invention is a self-contained, modular apparatus designed to provide users with a convenient, uniform, and safe method of applying sunscreen. The sunscreen fluid dispensing apparatus 1000 comprises the following components:

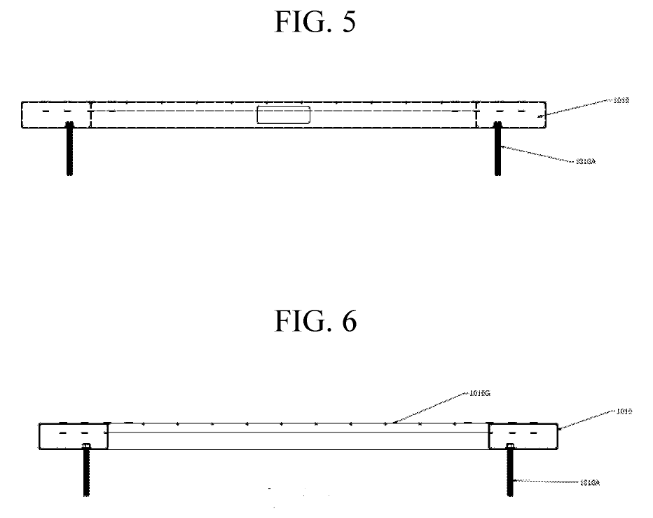

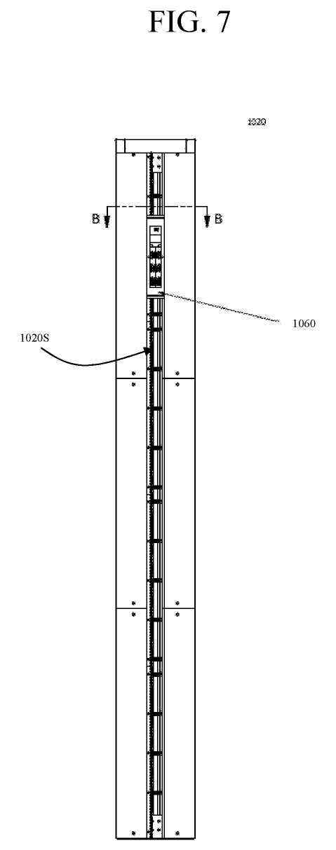

1. The base 1010 (e.g., raised deck) with a porous surface, constructed from UV-resistant materials such as reinforced polymer or treated aluminum. The base 1010 has a slotted or perforated surface which is configured to allows excess lotion to fall through the base 1010 into a catch basin, thereby preventing slip hazards. The base 1010 is mounted on anchor fixtures 1010A secured to the ground, with vibration-damping mounts to reduce noise, as shown in FIGS. 5 and 6.

2. The base 1010 includes a perimeter frame that encloses fluid piping and electrical wiring in protected channels for maintenance and weather resistance.

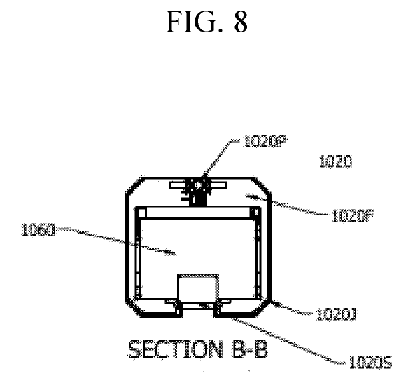

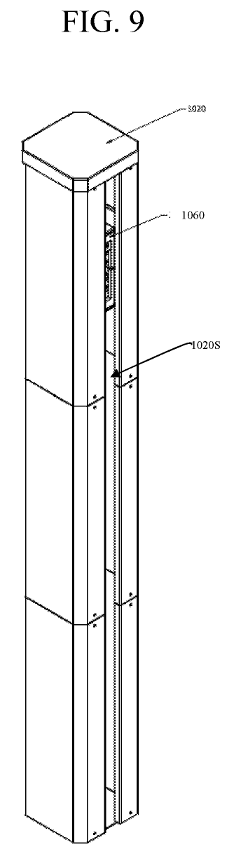

3. The sunscreen fluid dispensing apparatus 1000 includes the support posts 1020 and sprayer carriages 1060. In some embodiments, four vertical support posts are positioned at the corners of the base 1010, as shown in FIGS. 1-3. Each of the posts 1020 are formed from dual aluminum extrusions with a front-facing slot 1020S. A rear side of each post 1020 includes an extruded aluminum beam with an integrated spur gear rack 1020T located inside the support post 1020. A sheet metal plate 1020F (see FIG. 8) forms the bottom of the post 1020 and bolts to the base 1010. A similar plate is located at the top of the post 1020. These plates 1020F hold the post 1020 upright and help support the surrounding sheet metal. The sprayer carriage includes a motor 1020Y (e.g., stepper motor with a brake) which drives the gear 1020PG which engages the rack 1020T to move the sprayer carriage 1060 vertically. As shown in FIG. 8 an extruded beam secures the gear 1020PG and the surrounding sheet metal structure.

The sprayer carriage 1060 includes six solenoid valves (three sunscreen valves 1060V for lotion SPFs, three air valves 1060VA for compressed air). The sprayer carriage 1060 includes atomizing nozzles 1060N for fine mist delivery of the sunscreen fluid. The sprayer carriage 1060 includes the sensor 1060L (see FIG. 17), for example, the laser distance sensor for user height and position detection. The sprayer carriage 1060 includes a printed circuit board for control, local logic and communication.

3. The sunscreen fluid dispensing apparatus 1000 is an automated spray system with dedicated SPF lotion reservoirs 1030Q in the utility box 1030 connected via tubing 1060Y, 1060X to the air valves 1060VA and the sunscreen valves 1060V mounted in the sprayer carriage 1060. The air compressor 1030A supplies compressed air to the air valves 1060VA and the sunscreen valves 1060V mounted in the sprayer carriage 1060. Coordinated spray cycles on opposing carriages 1060 deliver uniform full-body coverage.

4. The sunscreen fluid dispensing apparatus 1000 includes user sensing and safety interlocks, for example, the laser distance sensors 1060L and optional ultrasonic sensors detect user position on the base 1010. The computer processing unit 1030C automatically halts the sprayer carriage 1060 before reaching the user's facial region. Emergency stop buttons and manual overrides are provided.

5. The sunscreen fluid dispensing apparatus 1000 includes a manual face dispense box 1090, for dispense sunscreen fluid for the user to apply to facial area, as shown in FIGS. 1, 18A and 18B. The manual face dispense box is attached to one support post 1020, with three dispense solenoids 1090X, tubing 1090T and pumps. A touchscreen or mobile Graphical User Interface 1090GUF selection triggers measured amounts of sunscreen lotion or fluid doses into the user’s hands via a cavity 1090D located in a front side of the manual face dispense box 1090. A high-resolution display offers instructions, status, and QR codes for mobile app integration.

6. The sunscreen fluid dispensing apparatus 1000 includes the utility box 1030, which encloses reservoirs 1030Q, the pumps 1030P, the air compressor 1030A, a breaker panel, the computer processor 1030C and a main control board. In some embodiments, optional solar panels 1030PP and battery bank 1030BB are provided on or adjacent to the utility box 1030 to enable off-grid operation. The solar panel 1030PP is configured to provide electricity to the battery bank 1030BB, the pumps 1030P, the computer processing unit 1030C, the air valve 1060VA, the sunscreen valve 1060V, and/or the motor 1020Y. In some embodiments, the sunscreen fluid dispensing apparatus 1000 includes integrated wireless modem for remote diagnostics, inventory tracking, and software updates.

In the description of the present application, it should be noted that the orientation or position relationships indicated by the terms such as "center", "top", "bottom", "left", "right", "vertical", "horizontal", "inside" and "outside" are based on the orientation or position relationships illustrated in the drawings, for the purpose of conveniently describing the present application and simplifying the description, rather than indicating or implying that the device or component referred to must have a specific orientation and be constructed and operated in a specific orientation, and shall not be understood as limitations to the present application. In addition, the terms "first", "second" and "third" are used only for the purpose of description and shall not be understood as indicating or implying relative importance.

The disclosure is not limited to the foregoing illustrative examples and the examples should be considered in all respects as illustrative and not restrictive, reference being made to the appended claims, rather than to the foregoing examples, and all changes which come within the meaning and range of equivalency of the claims are therefore intended to be embraced.

In the specification, the singular forms also include the plural forms, unless the context clearly dictates otherwise. Unless defined otherwise, all technical and scientific terms used herein have the same meaning as commonly understood by one of ordinary skill in the art to which this invention belongs. In the case of conflict, the present specification will control.

What is claimed is:

1. A sunscreen fluid dispensing apparatus comprising:
a sunscreen reservoir system for dispensing the sunscreen fluid, the sunscreen reservoir being in fluid communication with at least one pump;
an air compressor;
at least one post mounted to a base; and
a sprayer carriage movably mounted to the at least one post, the sprayer carriage being in fluid communication with the air compressor and the at least one pump, the sprayer carriage having at least one nozzle mounted thereon and configured to discharge a mixture of air and the sunscreen fluid through a discharge port of the at least one nozzle.

2. The sunscreen fluid dispensing apparatus of claim 1, wherein the sprayer carriage is moveably mounted on a toothed rack and is driven by a gear, and a motor configured to drive the gear, the sprayer carriage being supported by a V-wheel or rod end that rolls in a linear groove.

3. The sunscreen fluid dispensing apparatus of claim 1, wherein the sprayer carriage slides in a track, preferably a linear groove and is mounted on a timing cable or belt wrapped around an upper pulley and a lower pulley, the timing cable or belt is driven by a stepping motor to translate the sprayer carriage relative to the post.

4. The sunscreen fluid dispensing apparatus of claim 1, wherein the sprayer carriage comprises at least one air valve configured to selectively control flow of air through the at least one nozzle and at least one sunscreen valve configured to selectively control flow of the sunscreen fluid through the at least one nozzle.

5. The sunscreen fluid dispensing apparatus of claim 1, wherein the sunscreen reservoir system is configured for storing sunscreen fluids having different sun protection factors.

6. The sunscreen fluid dispensing apparatus of claim 1, further comprising a computer processing unit having executable software configured for controlling a position of the sprayer carriage and for controlling the open/closed position of the at least one sunscreen valve and the at least one air valve.

7. The sunscreen fluid dispensing apparatus of claim 1, further comprising a control and status panel mounted on the at least one post, the control and status panel being in communication with the computer processing unit and being configured to receive user selections of the sunscreen fluids and payment methods.

8. The sunscreen fluid dispensing apparatus of claim 1, further comprising a camera mounted on the at least one post and in communication with the computer processing unit.

9. The sunscreen fluid dispensing apparatus of claim 1, comprising four of the posts mounted diametrically opposite one another on the base and with the at least one nozzle facing each other.

10. The sunscreen fluid dispensing apparatus of claim 1, further comprising wind break walls extending between adjacent pairs of the posts.

11. The sunscreen fluid dispensing apparatus of claim 1, wherein the base comprises a grate mounted therein and configured for supporting a user.

12. The sunscreen fluid dispensing apparatus of claim 1, further comprising a solar panel configured to provide electricity to at least one of a battery bank, the pumps, the computer processing unit, the air valve, the sunscreen valve, and the motor.
